(19) United States
(12) Patent Application Publication
(10) Pub. No.: US 2017/0315971 A1
(43) Pub. Date: Nov. 2, 2017

(54) PROGRAM FOR DISPLAYING WEBPAGE, TERMINAL DEVICE, AND SERVER DEVICE

(71) Applicant: SYMMETRIC CO., LTD., Tokyo (JP)

(72) Inventors: Kazutoshi SAKATA, Tokyo (JP); Shintaro EGASHIRA, Tokyo (JP); Jun NAKANISHI, Tokyo (JP)

(73) Assignee: SYMMETRIC CO., LTD., Tokyo (JP)

(21) Appl. No.: 15/517,235

(22) PCT Filed: Oct. 6, 2014
(86) PCT No.: PCT/JP2014/076729

§ 371 Date: Apr. 6, 2017

(51) Int. Cl. G06F 17/22; G06F 17/30

(52) U.S. Cl. CPC G06F 17/2247; G06F 17/30961; G06F 17/227; G06F 17/30896

(57) ABSTRACT

A proxy server device adds, to a script in the document data of a Web page that is transmitted from a Web server device to a terminal device, a code Y that instructs an event generation of script execution, and, once a script X, which modifies a DOM tree of a Web page displayed according to the document data according to predetermined rules, has been added to the document data, transmits the document data to a terminal device. The terminal device generates an event according to code Y in compliance with the execution of a script included in the received document data. The terminal device modifies the DOM tree according to script X in compliance with predetermined rules, by using the event as a trigger. The terminal device displays a Web page according to the modified DOM tree.

### TECHNICAL FIELD

The present invention pertains to a technique for displaying Web pages in a terminal device.

### BACKGROUND

A technique of displaying Web pages distributed from a server device by using Web browsers executed at a terminal device is commonly practiced. When a distributer of a Web page wishes to modify content of a Web page, it is generally necessary for the designer of the Web page to first modify the Web page and then upload the modified Web page to a server device.

Japanese Patent Application Publication No. JP2014-507036A (“Patent document 1”) discloses a technique for making rapid changes to a Web page. Specifically, patent document 1 discloses a technique of modifying a display content of a Web page, whereby a client application intercepts a request to render target content included in a Web page, and replaces, with requested target content, content selected based on predetermined references from among one or more items of replacement content having different elements to those of the requested target content.

According to the technique disclosed in patent document 1, for example, to improve advertising in a Web page, the language included in the Web page can be easily modified according to attributes of a person browsing the Web page or the like.

The basic configuration of a Web page is currently described using HTML, XML XHTML, or the like. Hereafter, data describing a basic configuration of Web pages will be referred to as a “document”. In recent years, for modifying an appearance of a Web page it has been common practice to apply to a document of a Webpage that is marked up in a language such as HTML a style sheet that specifies an appearance of the Webpage. Currently, languages such as CSS, DSSSL or XSL are used for these style sheets.

A document of a Web page may include a program. A program included within the document of a Web page is in text format, and a large proportion thereof is described using a simple interpreter-type language, and is therefore often referred to as a “script”. Hereafter, for convenience, in the present application a program that is included within the document of a Web page is referred to as a “script”. However, herein the terms “script” and “program” are used synonymously. That is, in the present application, the term “script” does not delimit whether a programming language used to describe a program thereof as simple, regardless of whether the language is an interpreter-type language, or the like. Moreover, the term “carrying out a script” includes execution of a program that is called by the script. That is, it is not necessary for a script to describe all codes that are executed.

A script is interpreted and run by a Web browser. A script enables switching of content displayed within a Web page, modification of a document or a style sheet displayed within the Web page, and the like. Accordingly, a designer of a Web page is able to design an expressive Web page, such as a Web page that functions interactively while people browse the Web page, a Web page in which display content changes according to attributes of people browsing the Web page, a browsing time, browsing location and the like of the Web page, by including a script within in the document of the Web page.

JavaScript (registered trademark), VB script, DHTML and the like are currently used as scripts. Ajax and the like, which transmit HTTP requests to a predetermined server device using JavaScript, acquire, from the server device, the document of a new Web page marked up in HTML or the like, and modify a display content of a Web page in an asynchronous manner relative to operation or the like by a person browsing a Web page, are becoming more widespread.

It is sometimes necessary to modify an existing Web page according to predetermined rules. Typical examples of modifications include, collectively replacing specific words displayed on a Web page with other words, reducing a resolution of an image displayed on a Web page by a predetermined ratio, modifying a specific font to another font, and modifying an HTML attribute value to another value.

Of the elements and attributes of a Web page, concerning those described within a document (excluding the script portion) described using HTML or the like and a style sheet by using CSS or the like, modifications to the Web page according to predetermined rules can be easily made by replacing text described using such languages according to the predetermined rules.

Meanwhile, of the elements and attributes of a Web page, those determined according to script execution cannot be easily modified according to a predetermined rule. This is because a script is a program, and since a content executed by a script changes depending on an environment in which a Web page is displayed, and input data and the like, elements or attributes thereof displayed within a Web page according to a script cannot be specified from the script itself.

Accordingly, in the prior art, if modifications were to be added to a Web page based on predetermined rules, in relation to scripts within documents in a Web page, it is necessary for a Web designer to modify the script itself, and content acquired by carrying out the script, and the like independently of one another. Therefore, a Web page in which a script is used has an advantage of being able to provide expressive display content to a person browsing the Web page, but suffers from a disadvantage in that it has limited capacity for maintenance.

### SUMMARY

In consideration of the above-stated background, the purpose of the present invention is to provide a means for enabling reflection of modifications according to predetermined rules with ease, with respect to Web pages within which scripts are used.

To solve the above-stated problem, the present invention provides, as a first embodiment, a computer program that causes a computer to execute processes comprising: a determination process for determining whether a tree structure indicated by generated tree data includes one or more branches that satisfy predetermined conditions; a modification process for modifying the one or more branches according to predetermined rules if it is determined in the determination process that one or more branches that satisfy the predetermined conditions are included; and a display instruction process for instructing a display device to display a Web page according to the tree data that has been modified in the modification process, the computer generating tree data indicating in a tree structure relations among elements included in a Web page that is displayed according to display instruction data, and which instructs display of a Web page.

In a second embodiment, there is adopted a configuration in which the program according to the above-described first embodiment causes the computer to carry out processes comprising: a detection process for detecting generation of a predetermined event, and the determination process if generation of a predetermined event is detected in the detection process.

In a third embodiment, there is adopted a configuration in which the program according to the second embodiment causes the computer to carry out a process comprising: modification, in the modification process, of branches according to the predetermined rules that differ according to the predetermined event that has been detected as being generated in the detection process.

In a fourth embodiment, there is adopted a configuration in which the program according to the third embodiment causes the computer to carry out a process comprising: detection, in the detection process, of execution by the computer of a program according to the display instruction data or execution by the computer of a code included in the program as generation of the predetermined event that differs from the program or the code.

In a fifth embodiment, there is adopted a configuration in which the program according to the second or third embodiment causes the computer to carry out a process comprising: detection, in the detection process, of execution by the computer a program according to the display instruction data or execution by the computer of a code included in the program as generation of the predetermined event.

In a sixth embodiment, there is adopted a configuration in which the program according to any one of embodiments 1-5, comprising: at least a part that is included in the display instruction data.

In a seventh embodiment, there is adopted a computer program that causes a computer, which transmits, to a terminal device, display instruction data that instructs display of a Web page, to carry out processes comprising: an adding process for adding a code that causes the terminal device to generate an event indicating execution of a program or a code included in the program, if at least a part of the program is included in the display instruction data, and a transmission process for transmitting, to the terminal device, the display instruction data to which a code has been added in the adding unit.

In an eighth embodiment, there is adopted a configuration in which the program according to the seventh embodiment, which causes the computer to carry out a process comprising: addition, in the adding process, of a code that causes the terminal device to generate events that differ according to a program or a code included in the program to be executed, as events that indicate execution of the program or the code.

In a ninth embodiment, there is adopted a computer program that causes a computer, which transmits, to a terminal device, display instruction data that instructs display of a Web page, to carry out processes comprising: an adding process for adding, to the display instruction data, a program that causes the terminal device to carry out a process of acquiring the program set forth in any one of the first to fifth embodiments from a server device, and a transmission process for transmitting, to the terminal device, the display instruction data to which the program has been added in the adding process.

In a tenth embodiment, there is provided a configuration in which, in the program according to the ninth embodiment, the program added to the display instruction data in the adding process causes the terminal device to carry out a process of transmitting, to a server device, attribute data indicating attributes of the terminal device or attributes of a user of the terminal device.

In an eleventh embodiment, there is adopted a program that causes a computer, which transmits, to a terminal device, display instruction data that instructs display of a Web page, to carry out processes comprising: an adding process for adding, to the display instruction data, the program set forth in any one of the first to fifth embodiments, and a transmission process for transmitting, to the terminal device, the display instruction data to which the program has been added in the adding process.

In a twelfth embodiment, there is adopted a terminal device comprising: an acquisition unit for acquiring display instruction data that instructs display of a Web page; a generation unit for generating tree data that indicates, by using a tree structure, relations among elements included in the Web page that is displayed according to the display instruction data acquired by the acquisition unit; a determination unit for determining whether or not the tree structure indicated by the tree data generated by the generation unit includes one or more branches that satisfy predetermined conditions; a modification unit for modifying the one or more branches according to predetermined rules if it is determined by the determination unit that one or more branches that satisfy the predetermined conditions are included; and a display instruction unit for instructing a display device to display a Web page according to the tree data generated by the generation unit, and if the tree data has been modified by the modification unit, instructs the display device to display a Web page according to the modified tree data.

In a thirteenth embodiment, there is adopted a configuration in which the terminal device according to the twelfth embodiment comprises a detection unit for detecting generation of a predetermined event, wherein the determination unit carries out the determination if generation of the predetermined event is detected by the detection unit.

In a fourteenth embodiment, there is adopted a configuration in which, in the terminal device according to the thirteenth embodiment, the modification unit modifies branches according to the predetermined rules that differ according to the predetermined event for which generation has been detected by the detection unit.

In a fifteenth embodiment, there is adopted a configuration in which the terminal device according to the fourteenth embodiment comprises an execution unit for executing a program according to the display instruction data or a process according to a code included in the program, wherein the detection unit detects events that differ according to the program or the code executed by the execution unit.

In a sixteenth embodiment, there is adopted a configuration in which the terminal device according to the thirteenth or fourteenth embodiment comprises an execution unit for executing a process according to a program according to the display instruction data or a code included in the program, wherein the detection unit detects execution of the program or the code included in the program by the execution unit as generation of an event.

In a seventeenth embodiment, there is adopted a server device comprising:

an adding unit for adding a code that causes a terminal device to generate an event that indicates execution of a program or a code included in the program, if at least a part of the program is included in display instruction data that instructs display of a Web page, and a transmission unit for transmitting, to the terminal device, the display instruction data to which the code has been added by the adding unit.

In an eighteenth embodiment, there is adopted a configuration in which, in the server device according to the seventeenth embodiment, the adding unit adds a code that causes the terminal device to generate events that differ according to a program or a code included in the program to be executed, as an event that indicates execution of the program or the code.

In a nineteenth embodiment, there is adopted a server device comprising:

an adding unit for adding, to display instruction data that instructs display of a Web page, a program that causes a terminal device to acquire the program set forth in any one of the first to fifth embodiments from the server device, and a transmission unit for transmitting, to the terminal device, the display instruction data to which the program has been added by the adding unit.

In a twentieth embodiment, there is adopted a configuration in which, in the server device according to the nineteenth embodiment, the adding unit adds, to the display instruction data, a program that causes the terminal device to carry out a process of transmitting, to the server device, attribute data that indicates attributed of the terminal device or attributes of a user of the terminal device.

In a twenty first embodiment, there is adopted a server device comprising an adding unit for adding, to display instruction data that instructs display of a Web page, the program set forth in any one of the first to fifth embodiments, and a transmission unit for transmitting, to a terminal device, the display instruction data to which the program has been added by the adding unit.

According to the present invention, even if a program is included within display instruction data that instructs display of a Web page, if tree data that reflects the results of execution of the program satisfies predetermined conditions, the tree data is modified according to predetermined rules; therefore, modifications to the Web page according to predetermined rules is achieved with ease regardless of the presence/absence of a script.

### BRIEF DESCRIPTION OF THE DRAWINGS

FIG. 1 A drawing illustrating the overall configuration of a Web page display system according to the first embodiment.

FIG. 2 A drawing illustrating the hardware configuration of a terminal device according to the first embodiment.

FIG. 3 A drawing illustrating the functional configuration of a terminal device according to the first embodiment.

FIG. 4 A drawing illustrating the hardware configuration of a proxy server device according to the first embodiment.

FIG. 5 A drawing illustrating the functional configuration of a proxy server device according to the first embodiment.

FIG. 6 A drawing illustrating the hardware configuration of a Web server device according to the first embodiment.

FIG. 7 A drawing illustrating the functional configuration of a Web server device according to the first embodiment.

FIG. 8 A drawing illustrating the processing sequence carried out by a Web page display system according to the first embodiment.

FIG. 9 A drawing exemplifying document data prior to the addition of a code that generates an event according to execution of a script in a proxy server device according to the first embodiment.

FIG. 10 A drawing illustrating document data subsequent to the addition of a code that generates an event according to execution of a script in the proxy server device according to the first embodiment.

FIG. 11 A drawing illustrating the configuration of rule data added to document data in a proxy server device according to the first embodiment.

FIG. 12 A drawing exemplifying tree data generated in a terminal device according to the first embodiment.

FIG. 13 A drawing exemplifying tree data generated in a terminal device according to the first embodiment.

FIG. 14 A drawing exemplifying a Web page displayed in a terminal device according to the first embodiment.

FIG. 15 A drawing illustrating a processing sequence carried out by a Web page display system according to the first embodiment.

FIG. 16 A drawing exemplifying a script prior to the addition of a code that generates an event according to execution in a proxy server device according to the first embodiment.

FIG. 17 A drawing exemplifying a script subsequent to the addition of a code that generates an event according to execution in a proxy server device according to the first embodiment.

FIG. 18 A drawing illustrating the processing flow carried out by a terminal device according to the first embodiment.

FIG. 19 A drawing exemplifying a part of a script that instructs a terminal device regarding the process of modifying tree data according to the first embodiment.

FIG. 20 A drawing exemplifying tree data generated in a terminal device according to the first embodiment.

FIG. 21 A drawing exemplifying a Web page displayed in a terminal device according to the first embodiment.

### DETAILED DESCRIPTION

Following is an explanation of a Web page display system 1 according to the first embodiment of the present application. Web page display system 1 enables a designer of the Web page to make modifications to the Web page according to predetermined rules with ease, even if the Web page includes a script.

FIG. 1 is a drawing illustrating the overall configuration of Web page display system 1. Web page display system 1 comprises a terminal device 11, a proxy server device 12, and a Web server device 13. Terminal device 11, proxy server device 12 and Web server device 13 is connected to a network 9. Terminal device 11 and Web server device 13 communicate with each other via network 9.

Terminal device 11 displays a Web page to a person browsing the Web page (hereafter referred to as “user”). Proxy server device 12 relays data communication between terminal device 11 and Web server device 13, and behaves as a proxy device of terminal device 11 with respect to Web server device 13. Web server device 13 transmits, to terminal device 11, various types of data required to display a Web page according to a request from terminal device 11.

For convenience of explanation, FIG. 1 illustrates one of each of terminal device 11, proxy server device 12 and Web server device 13, but two or more of these devices may be provided. For example, the number of terminal devices 11 varies according to the number of users (people browsing the Web page) that uses Web page display system 1. Moreover, the number of Web server devices 13 varies according to the amount, type and the like of various types of content used to display a Web page.

The various types of data required to display a Web page that is transmitted from Web server device 13 to terminal device 11 are display instruction data that instructs display of a Web page, content data that indicate the content of an image or the like that is displayed on a Web page, and the like. Display instruction data that instructs display of a Web page includes document data that is described using a language such as HTML and that indicates the document of a Web page, style sheet data that is described using a language such as CSS and that indicates the appearance of a Web page, and the like. Document data sometimes includes a script. The portion of document data that indicates a script is also a portion of display instruction data.

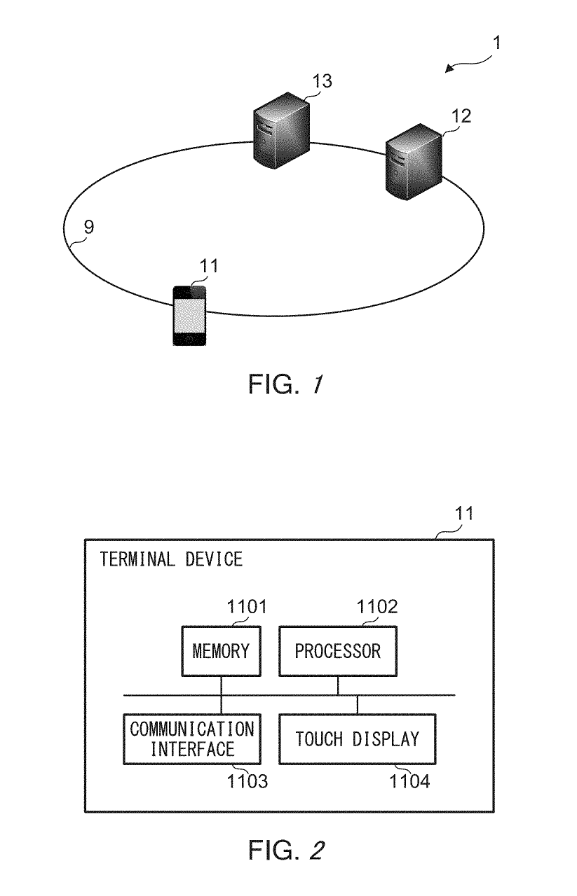

FIG. 2 is a drawing illustrating one example of the hardware configuration of terminal device 11. The hardware configuration of terminal device 11 is a computer for a terminal device. The computer exemplified in FIG. 2 is a tablet-type computer with a built-in touch display, and comprises a memory 1101 that stores various types of data, a processor 1102 that carries out various processes according to a program stored in memory 1101, a communication interface 1103 that performs data communication with other devices via network 9, and a touch display 1104 that displays various types of images to a user in addition to accepting touch operations by the user.

The type of computer used in terminal device 11 is not limited to a tablet-type computer, and may be a notebook-type computer, a desktop-type computer, or the like. Accordingly, terminal device 11 may comprise a display device such as a liquid-crystal display and an operation device such as a keyboard or a mouse independently of the device in place of touch display 1104. Moreover, terminal device 11 may have a configuration in which at least a part of the display device and operation device is not built in, an input/output interface that performs data input/output with external devices is provided, and terminal device 11 performs input/output of various types of data with an external display device or operation device that is connected to the input/output interface.

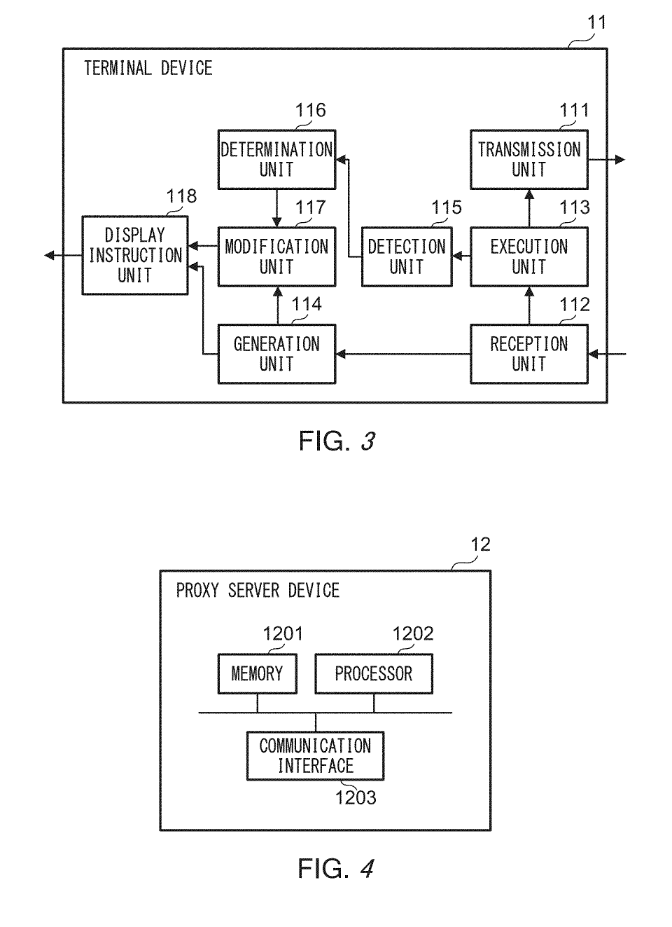

FIG. 3 is a drawing illustrating the functional configuration of terminal device 11. That is, the computer comprising the hardware configuration illustrated in FIG. 2 functions as a device comprising the components illustrated in FIG. 3 by carrying out processes according to a program. Terminal device 11 comprises, as functional components: a transmission unit 111 that firstly transmits, to Web server device 13, a request for various types of data or the like required to display a Web page via proxy server device 12; a reception unit (an example of an acquisition unit) that receives, from Web server device 13, the various types of data or the like required to display the Web page via proxy server device 12; an execution unit 113 that carries out various processes according to a script or the like included within the document data of the Web page; and a generation unit 114 that generates tree data that illustrates the relations among elements included within the Web page displayed according to the display instruction data of the Web page.

Terminal device 11 further comprises a detection unit 115 for detecting generation of a predetermined event, a determination unit 116 for determining whether or not the tree structure shown by tree data generated by generation unit 114 includes one or more branches that satisfy predetermined conditions, a modification unit 117 for modifying the one or more branches according to predetermined rules if determination unit 116 determines that the tree structure includes one or more branches that satisfy predetermined conditions, and a display instruction unit 118 for instructing a display (one example of a display device) provided in touch display 1104 regarding display of a Web page according to tree data generated by generation unit 114 or tree data modified by modification unit 117.

FIG. 4 is a drawing illustrating one example of the hardware configuration of proxy server device 12. The hardware configuration of proxy server device 12 is a computer for a general server device. The computer exemplified in FIG. 4 comprises a memory 1201 that stores various types of data, a processor 1202 that carries out various types of processes according to a program stored in memory 1201, and a communication interface 1203 that performs data communication with other devices via network 9.

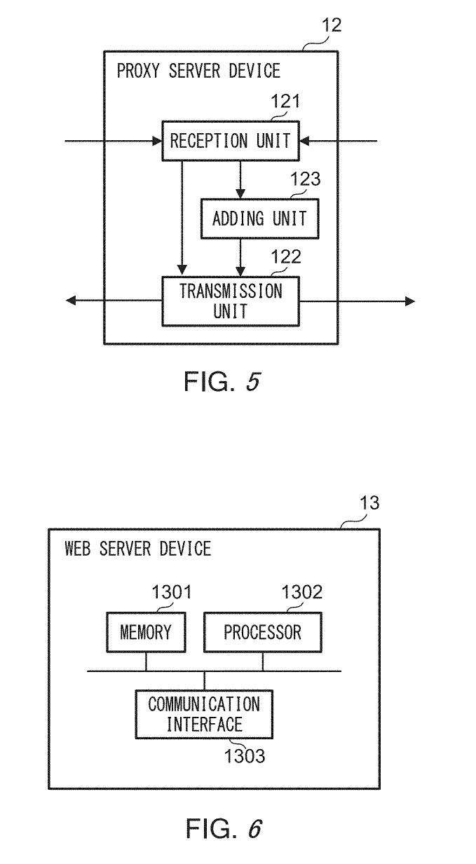

FIG. 5 is a drawing illustrating the functional configuration of proxy server device 12. That is, the computer comprising the hardware configuration illustrated in FIG. 4 functions as a device comprising the components illustrated in FIG. 5 by carrying out processes according to a program. Proxy server device 12 comprises, as functional components, a reception unit 121 for receiving various types of data from terminal device 11 and Web server device 13, a transmission unit 122 for transmitting various types of data to terminal device 11 and Web server device 13, and an adding unit 123 for adding a script or a code to the display instruction data of a Web page received from Web server device 13.

FIG. 6 is a drawing illustrating one example of the hardware configuration of Web server device 13. The hardware configuration of Web server device 13 is a computer for a general server device. The computer exemplified in FIG. 6 comprises a memory 1301 that stores various types of data, a processor 1302 that carries out various types of processing according to a program stored in memory 1301, and a communication interface that performs data communication with other devices via network 9.

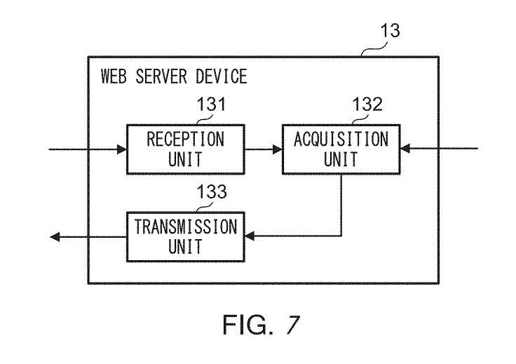

FIG. 7 is a drawing illustrating the functional configuration of Web server device 13. That is, the computer comprising the hardware configuration illustrated in FIG. 7 functions as a device comprising the components illustrated in FIG. 6 by carrying out processes according to a program. Web server device 13 comprises, as functional components, a reception unit 131 for receiving requests, from terminal device 11, for various types of data or the like required to display a Web page via proxy server device 12, an acquisition unit 132 for reading and acquiring display instruction data, content data and the like of the Web page stored in memory 1301 according to the requests received by reception unit 131, and a transmission unit for transmitting, to terminal device 11, the display instruction data, content data and the like of the Web page acquired by acquisition unit 132 via proxy server device 12.

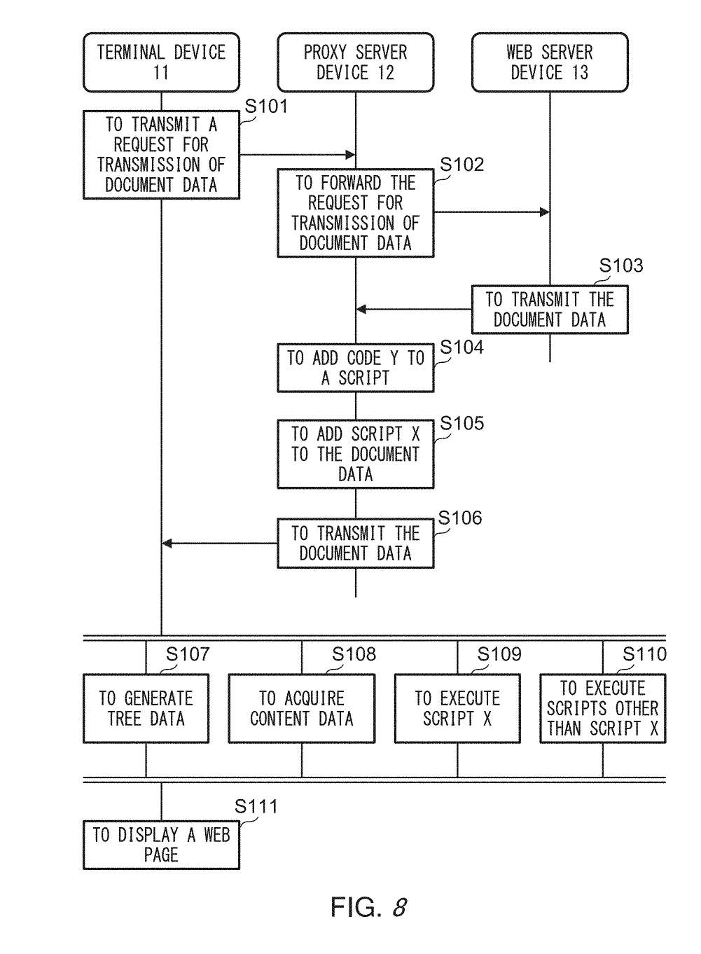

FIG. 8 is a drawing illustrating the outline of the sequence of processes carried out by Web page display system 1. First, a user inputs, in the Web browser that is executed in terminal device 11, the URI of a Web page to be displayed. The method for the user to input the URI is not limited to direct input of the URI, and may be any method such as touch operation of a button to which the URI is linked. Terminal device 11 transmits, to Web server device 13, request data for requesting transmission of the document data (a part of the display instruction data) of the Web page according to the URI that has been input (step S101).

The request data transmitted from terminal device 11 is received by proxy server device 12. Proxy server device 12 forwards the received request data to the destination Web server device 13 (step S102).

Web server device 13 transmits, to terminal device 11, the document data of the Web page according to the request data transmitted from proxy server device 12 via terminal device 11 (step S103). The document data transmitted from Web server device 13 is received by proxy server device 12. The adding unit 123 of proxy server device 12 adds, to a script that satisfies predetermined conditions from among the scripts included in the document data received from Web server device 13, a code (hereafter referred to as “code Y”) that dictates generation of an event according to the execution of the script (step S104).

In step S104, a predetermined condition satisfied by the script to which the adding unit 123 adds a code is, for example, including a predetermined code that has the possibility of applying modifications to the display content of a Web page, a code for which it is unclear whether modifications are applied to the display content of a Web page.

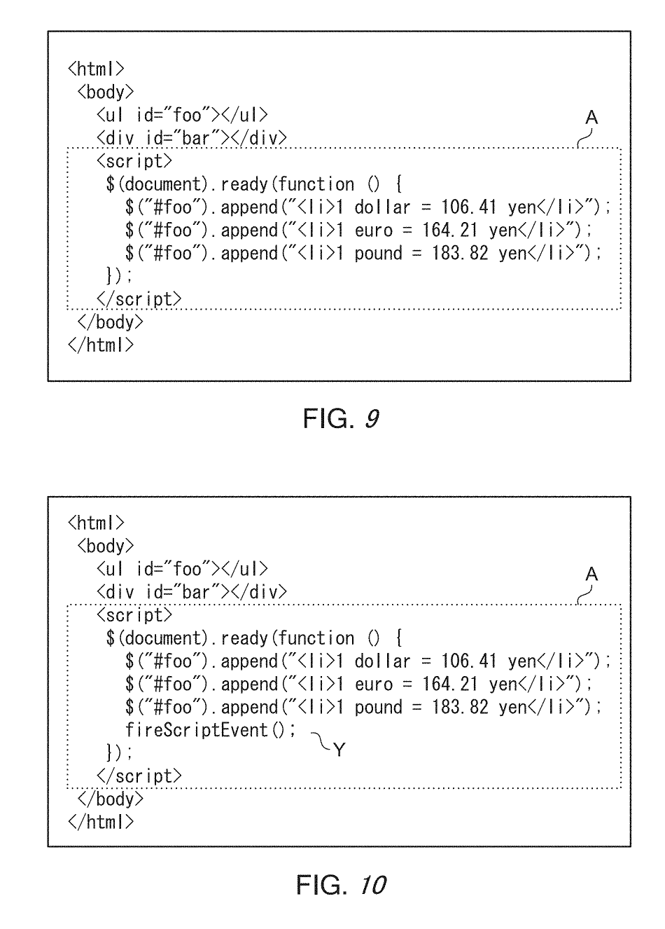

FIG. 9 is a drawing exemplifying document data prior to the addition of code Y in step S104. FIG. 10 is a drawing exemplifying document data subsequent to the addition of code Yin step S104. Script A illustrated in FIG. 9 and FIG. 10 is a script to which code Y can be added, and “fireScriptEvent( )” illustrated in FIG. 10 is code Y.

In the example illustrated in FIG. 10, code Y is added to the end of the script. The position to which code Y is added is not limited to the end of the script, and may be at the beginning of the script, after or before the predetermined various types of codes included in the script, or the like, for example. Moreover, in the example illustrated in FIG. 10, the number of codes Y added to one script is one, but two or more scripts may be added to one script.

Returning to FIG. 8, following is an explanation of the sequence processed in Web page display system 1. Subsequent to the process of step S104, adding unit 123 adds, to the document data, a script (hereafter referred to as “script X”) that dictates a process of modifying, according to predetermined rules, the tree data of a Web page displayed according to the document data (step S105). Here, step S104 and step S105 may be carried out in any order.

Script X includes rule data indicating rules for each type of event or modifications thereof, which serves as a trigger for the modification process of the tree data of a Web page. FIG. 11 is a drawing illustrating a configuration example of the rule data included within script X. Rule data is a collection of a plurality of items of parameter data, each of which is identified by a parameter ID. Script X modifies tree data according to different predetermined rules depending on the type of event according to the generation of various types of events, in line with the parameter data included in the rule data.

Each type of parameter data included within the rule data has, as fields, “parameter ID”, “event type”, and “modification rule”. Moreover, the field “event type” includes the subfields “event name” and “event generation object”, and the field “modification rule” includes the subfields “conditions” and “conversion code”.

The field “parameter ID” stores parameter IDs (stated above) that identify parameters. The field “event type” stores data indicating the type of event that serves as a trigger for execution of script X. That is, script X is executed when an event of a type identified by data stored in the subfield “event name” is generated in the object indicated by data stored in the subfield “event generation object”.

The field “modification rule” stores data indicating rules for modifications script X performs on tree data when an event of a type indicated by the data stored in the field “event type” is generated. That is, due to execution of script X, conversion of tree data according to a code stored in the subfield “conversion code” is performed if a branch (or a group of branches) that satisfies the conditions indicated by the data stored in the subfield “conditions” is searched from the tree structure indicated by the tree data.

Here, the event name “treechange” exemplified in FIG. 11 indicates an event in which the content of a branch (element) of an event generation object is modified. The event name “click” indicates an event in which an object indicated by a branch (element) of an event generation object has been clicked. The event name “code execution” indicates an invent in which the tree data has been modified according to the parameter data identified by a parameter ID of the event generation object.

Returning once again to FIG. 8, explanation of the sequence of processes in Web page display system 1 is continued. Proxy server device 12 has code Y added thereto by the process of step S104 as necessary, and transmits, to terminal device 11, document data to which script X is added by the process of step S105 (step S106).

If terminal device 11 receives document data of a Web page transmitted from proxy server device 12 according to request data transmitted in step S101, terminal device 11 performs, in parallel, generation of the tree data of the Web page (S107), acquisition of the content data required to display the Web page (step S108), execution of script X included in the document data (step S109), and execution of scripts other than script X included in the document data (step S110), according to the received document data.

Here, the number of times the process of each of steps S107-S110 is carried out is not limited to one, and may be carried out as many times as necessary. For example, generation of tree data of step S107 is carried out repeatedly in compliance with the execution of scripts in step S109 or S110. Moreover, executions of scripts that are not script X in step S110 are repeated the same number of times as the number of scripts included within the document data received by terminal device 11 in step S106, and are also repeated when content data including scripts is acquired in step S108. Execution of scrip X in step S109 is repeated in compliance with generation of events indicated by data stored in the field “event type” of the rule data. Furthermore, acquisition of content data in step S108 is repeated the same number of times as the number of referrals to external content indicated by the document data received by terminal device 11 in step S106, and is also repeated when content data including referrals to new external content is acquired in step S108. In FIG. 8, flow related to repeated execution of steps S107-S110 is omitted.

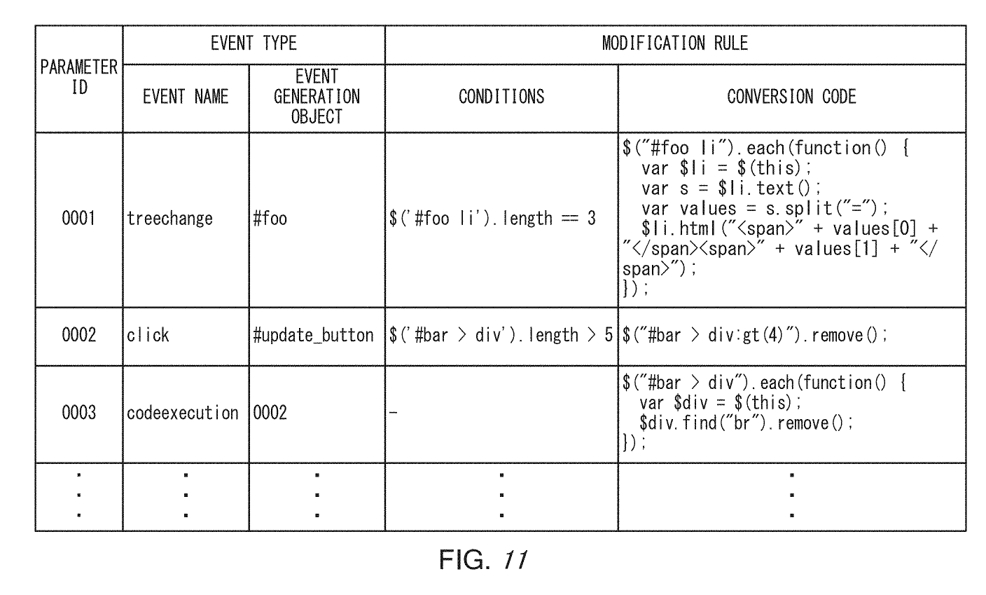

FIGS. 12 and 13 are drawings schematically illustrating tree data generated by generation unit 114 in step S107. A tree showing the relations among the elements of a Web page indicated by tree data is referred to as a DOM (Document Object Model) tree.

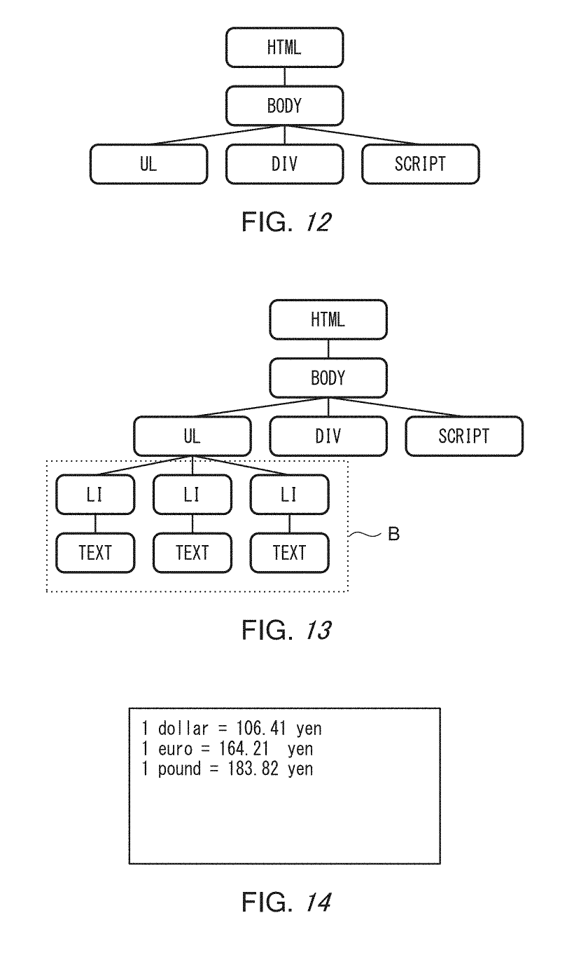

FIG. 12 illustrates a DOM tree shown by tree data generated by generation unit 114 in step S107 prior to execution of script A included within the document data by execution unit 113 in step S110. FIG. 13 illustrates a DOM tree shown by tree data generated by generation unit 114 in step S107 subsequent to execution of script A included within the document data by execution unit 113 in step S110. Branch group B illustrated in FIG. 13 is a portion indicating the elements added by execution of script A. As such, generation unit 114 generates tree data each time modifications are made to the display content of a Web page by execution of a script or the like, for example (step S107). FIG. 14 is a drawing schematically illustrating a Web page displayed according to the DOM tree illustrated in FIG. 13.

Returning once again to FIG. 8, explanation of the sequence of processes in Web page display system 1 is continued. In step S108, transmission unit 111 of terminal device 11 transmits request data for requesting transmission of content data to Web server device 13 according to a URI indicated in the document data (includes document data acquired according to the scripts included in the document data), and reception unit 112 receives content data transmitted as a response to the request data. Web server device 13, which is the destination of the request data of the content data in step S108, may or may not be the same as Web server device 13 that is the destination of the request data of the document data in step S101. If a plurality of items of request data of content data is transmitted in step S108, the request data may have different Web server devices 13 as destinations. In FIG. 8, illustration of the sequence of processes performed by Web page display system 1 according to step S108 is omitted.

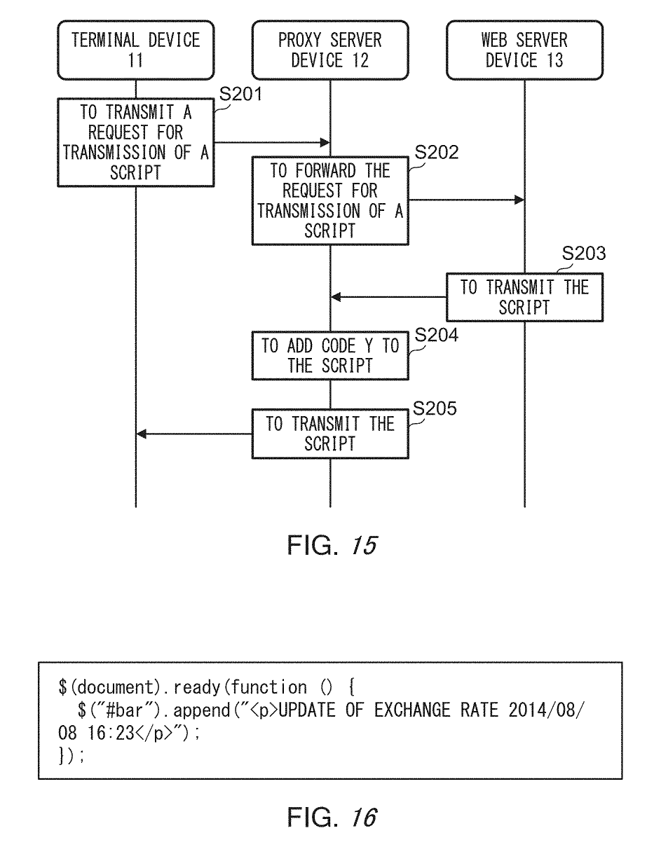

The content data acquired by terminal device 11 in step S108 is sometimes scripts. FIG. 15 is a drawing schematically illustrating the sequence of processes performed by Web page display system 1 when the content data acquired by terminal device 11 in step S108 are scripts.

Of steps S201-S205 of the sequence of processes illustrated in FIG. 15, steps S201-S204 have similar processes to those of steps S101-S104 of the sequence of processes illustrated in FIG. 8, and step S205 has a similar process to that of step S106. That is, when terminal device 11 acquires a script (or document data including a script) from Web server device 13 according to document data received in step S106, if the possibility of the script adding modifications to the DOM tree, or the possibility of adding modifications to the DOM tree exists, is unclear, code Y is added to the script by adding unit 123 of proxy server device 12, and the script to which code Y has been added is transmitted to terminal device 11.

FIG. 16 is a drawing exemplifying a script prior to the addition of code Y in step S204. FIG. 17 is a drawing illustrating a script subsequent to the addition of code Yin step S204.

Returning once again to FIG. 8, explanation of the sequence of processes in Web page display system 1 is continued. In step S109, detection unit 115, determination unit 116 and modification unit 117 of terminal device 11 execute script X. Script X is a script that instructs a process of modifying tree data according to data stored in the field “modification rule”, triggered by generation of an event of a type indicated by data stored in the field “event type” of the rule data (FIG. 11). Detection unit 115, determination unit 116 and modification unit 117 continue processes according to script X for the duration of display of a Web page according to document data received by terminal device 11 in step S106.

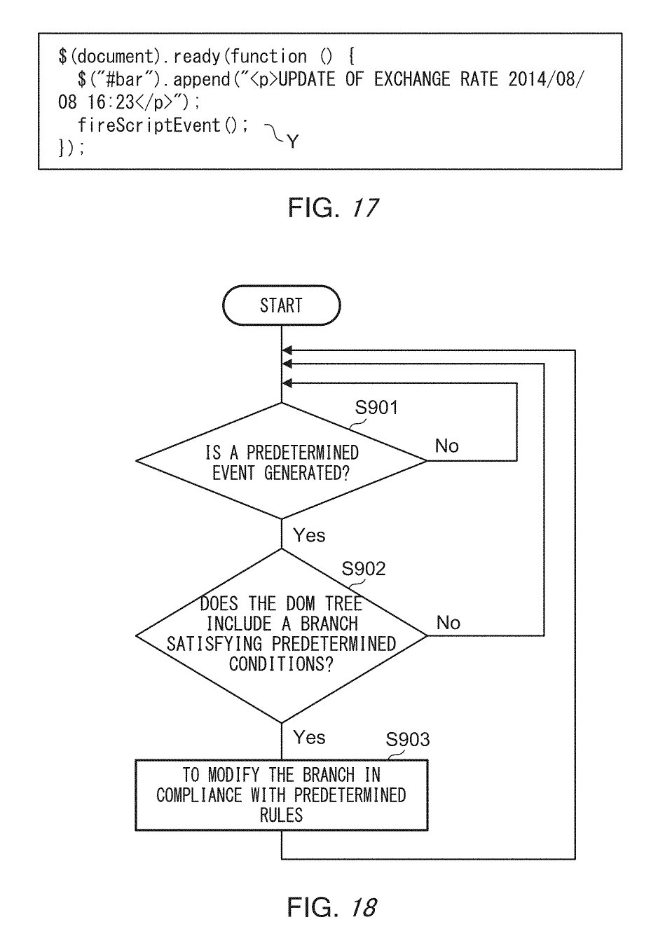

FIG. 18 is a drawing schematically illustrating the flow of processes performed by terminal device 11 according to script 11. First, detection unit 115 begins observation of the generation of a predetermined event (step S901). The predetermined event observed by detection unit 115 in step S901 is an event of a type indicated by data stored in the field “event type” in the rule data (FIG. 11). Such events, which are observation objects, include, in addition to events indicated by the data exemplified in FIG. 11, events generated by execution unit 113 according to code Y, that is, events indicating execution of a script. As observation object events, for example, various events may be adopted, such as events in which: generation of tree data according to document data received in step S106 is complete; a user performs a predetermined operation (modification of input category, modification of window size or the like) with respect to a Web browser; data communication of a Web browser with an external device is complete; and a branch (element) that has been modified by execution of a past script X (step S109) has been further modified by execution of another script (step S110).

If generation of a predetermined event is detected by detection unit 115 in step S901 (step S901: “Yes”), determination unit 116 determines whether a DOM tree indicated by tree data generated by generation unit 114 in that moment includes a branch (or a group of branches) that satisfies predetermined conditions (step S902). The predetermined conditions used for determination by determination unit 116 in step S902 are conditions indicated by data stored within the subfield “conditions”, for example, of the field “modification rules” of the rule data (FIG. 11).

If it is determined by determination unit 116 that a branch (or group of branches) that satisfies predetermined conditions does not exist within the DOM tree in step S902 (step S902: “No”), terminal device 11 reverts the process to step S901. Meanwhile, if it is determined by determination unit 116 that a branch (or group of branches) that satisfies predetermined conditions does exist within the DOM tree in step S902 (step S902: “Yes”), modification unit 117 modifies the branch (or group of branches) that satisfies the predetermined conditions in compliance with the predetermined rules according to the predetermined conditions (step S903). The predetermined rules used for modification by modification unit 117 in step S903 are rules indicated by data stored in the subfield “conversion code”, for example, of the field “modification rules” of the rule data (FIG. 11).

FIG. 19 is a drawing exemplifying a script that instructs terminal device 11 concerning steps S901-S903, that is, a part of script X (or a script acquired by terminal device 11 according to script X). If the predetermined condition “a text branch that includes “=” below a <li> tag branch exists” is satisfied, the script exemplified in FIG. 19 orders the text branch to be modified according to the predetermined rule “replace with a group of branches including a text branch on the left side of “=”, a text branch on the right side of “=”, and two <span> tag branches that hold the former branches in the bottom layer”.

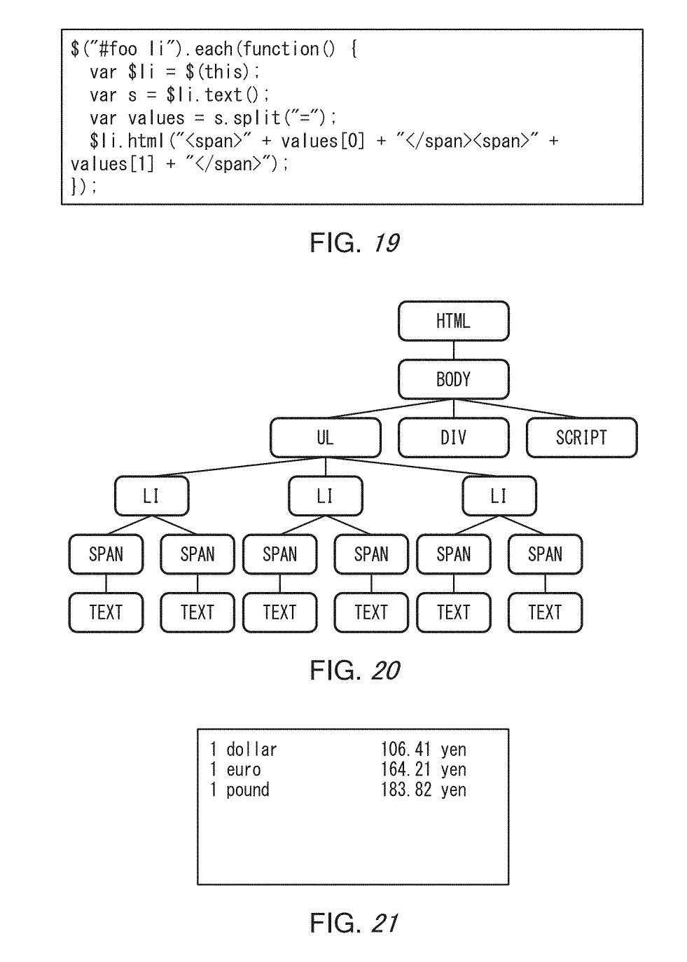

FIG. 20 is a drawing illustrating a DOM tree after the DOM tree exemplified in FIG. 13 has been modified according to the script exemplified in FIG. 19. FIG. 21 is a drawing illustrating a Web page displayed according to the DOM tree illustrated in FIG. 20. That is, due to a process according to script X, the display content of the Web page exemplified in FIG. 14 is modified to the display content exemplified in FIG. 21.

Returning once again to FIG. 8, explanation of the sequence of processes in Web page display system 1 is continued. In step S110, execution unit 113 of terminal device 11 executes a script (other than script X) included within the document data acquired by terminal device 11, and a script (for example, the script exemplified in FIG. 17) acquired according to the former script. In step S110, if a script including code Y is executed, execution unit 113 generates an event that indicates execution of a process according to the script according to code Y. The event generated by execution unit 113 is detected by detection unit 115 in step S901 in FIG. 18, determination unit 116 determines step S902 and modification unit 117 modifies step S903 by using the detection of event as a trigger. Therefore, if modifications are made to the DOM tree according to the script, modifications to the DOM tree subsequent to the former modification according to script X are made quickly and surely.

Display instruction unit 118 of terminal device 11 generates image data that indicates a Web page according to tree data generated by generation unit 114, and instructs touch display 1104 to display an image indicated by the image data (step S111). If modifications are made to the tree data in compliance with execution of a script (including script X), operation on the Web page by a user, or the like, display instruction unit 118 generates image data that indicates a Web page according to the tree data after modification, and instructs touch display 1104 to display an image indicated by the image data (step S111). Touch display 1104 displays the Web page according to the instructions from display instruction unit 118.

According to the above-stated Web page display system 1, a designer of a Web page is able to easily instruct a Web page of modifications according to predetermined rules by preparing data exemplified by rule data (FIG. 11).

The above-described explanation of the embodiment, indicates an example in which details of elements displayed on a Web page according to a script is described in the script is indicated in FIGS. 9 and 16, but this is for convenience of explanation, and a script handled by Web page display system 1 does not need to have the details of elements displayed on a Web page according to the script directly described in the script. This is because modifications to tree data in step S903 are not made based on the described details of a script, but are made based on the details of tree data generated in step S107. Accordingly, one particular effect obtained by the present invention is a feature in which, even if the behavior of a script included within the display instruction data of a Web page or a script acquired according to the display instruction data is unclear, modifications according to predetermined rules can be made to the Web page displayed as a result.

### Modifications

The above-described embodiment is one specific example of the present invention, and van be modified in various ways within the scope of technical ideas of the present invention. Examples of such modifications are indicated below. Here, the above-described embodiment and the below modifications may be combined, as appropriate.

### First Modification

In the above-described embodiment, addition of script X to document data of a Web page is performed in proxy server device 12. In place thereof, a configuration in which addition of script X to document data is performed in Web server device 13 may be adopted. In this modification, after receiving request data for requesting transmission of document data from terminal device 11, Web server device 13 may perform a process of adding script X to the requested document data, or transmit, to terminal device 11, the document data to which script X has been added according to the request data.

### Second Modification

In the above-described embodiment, script X is transmitted to terminal device 11 in a state of being added to the document data of a Web page. In place thereof, a configuration in which terminal device acquires script X independently of the document data may be adopted. In this modification, for example, proxy server device 12 adds a script (hereafter referred to as “script Z”) that instructs acquisition of script X to the document data in place of the addition of script X to the document data (FIG. 8, step S105). Terminal device 11 executes script Z included within the acquired document data (FIG. 8, step S110), acquires script X from Web server device 13 (FIG. 8, step S108), and subsequently executes script X (FIG. 8, step S109).

Furthermore, a configuration of including, in script Z, a code for instructing transmission, to Web server device 13, of attribute data indicating attributes of terminal device 11 or attributes of a user of terminal device 11 may be adopted. Here, attributes of terminal device 11 are, for example, device model of terminal device 11, resolution of the display, current communication state, current position, type of Web browser executed in terminal device 11 and the like. Moreover, attributes of a user of terminal device 11 are, for example, the gender, age, hobbies and the like of the user. According to this configuration, terminal device transmits attribute data in addition to request data for requesting transmission of script X to Web server device 13 according to script Z. Web server device 13 acquires a plurality of different items of rule data according to a terminal device or a user with various attributes in advance, and transmits, to terminal device 11, script X that includes rule data according to the attribute data transmitted in addition to the received request data from terminal device 11. As a result, modifications according to terminal device 11 or the user attributes of terminal device 11 are made to a Web page that is displayed in terminal device 11.

### Third Modification

In the above-described embodiment, terminal device 11 carries out processes for modifying tree data (FIG. 18, step S901-S903) according to script X acquired according to the acquisition of the document data of a Web page. In place thereof, a configuration in which terminal device 11 acquires, in advance, a program for instructing processes for modifying tree data, and performs processes for modifying tree data according to the program in the display of a Web page may be adopted. In this modification, the program that instructs processes for modifying tree data may be provided in a form of being incorporated in a Web browser that is carried out in terminal device 11, for example, or may be provided as an add-on program that expands the functions of the Web browser.

### Fourth Modification

In the above-described embodiment, code Y is added to scripts that satisfy predetermined conditions. In place thereof, a configuration in which code Y is added to all scripts may be adopted.

### Fifth Modification

In the above-described embodiment, code Y is added to scripts that satisfy predetermined conditions. In place thereof, a configuration in which code Y is not added to any script may be adopted. According to this modification, the processes of steps S902 and S903 in FIG. 18 are not necessarily performed at timings in which scripts are executed. However, if events (tree modification events and the like) other than events that are generated according to code Y are suitably set in the field “event type” of the rule data (FIG. 11), steps S902 and S903 are performed at sufficient frequencies, and rapid modifications are made to a Web page.

### Eighth Modification

In the above-described embodiment, addition of code Y to scripts that satisfy predetermined conditions included in the document data of a Web page are performed in proxy server device 12. In place thereof, a configuration in which addition of code Y to document data is performed in Web server device 13 may be adopted. In this modification, Web server device 13 may perform the process of adding code Y to requested document data after request data for requesting transmission of document data is received from terminal device 11, or may transmit, to terminal device 11, document data to which code Y was added in advance according to the request data.

### Ninth Modification

In the above-described embodiment, each of terminal device 11, proxy server device 12 and Web server device 13 is realized by execution of processes in a computer in compliance with a program. In place thereof, one or more of terminal device 11, proxy server device 12 and Web server device 13 may be configured as a dedicated device for achieving the functions schematically illustrated in FIGS. 3, 5 and 7 by an integrated circuit or the like.

### Tenth Modification

In the above-described embodiment, if the URI of the acquisition source of a script is described in the document data, terminal device 11 acquires the document data (FIG. 8, step S106), and subsequently acquires the script from the URI (FIG. 8, step S108). In place thereof, a configuration in which proxy server device 12 acquires the script may be adopted.

In this modification, if document data is transmitted from Web server device 13 to terminal device 11 according to a request from terminal device 11, proxy server device 12 acquires the script from Web server device 13 according to the URI described in the document data, and adds the script to the document data. When doing so, addition unit 123 adds code Y to the script as necessary (FIG. 8, step S104).

### Eleventh Modification

In the above-described embodiment, rule data (FIG. 11) is included within script X. In place thereof, a configuration in which script X does not include rule data, and terminal device 11 acquires rule data independently of script X may be adopted.

### Twelfth Modification

In the above-described embodiment, if a plurality of codes Y are added to a script, the codes Y are not differentiated from one another. Accordingly, an event generated in compliance with the execution of codes Y are not differentiated so as to identify which event indicates execution of which script. In place thereof, a configuration in which different events are generated according to the location in which code Y is added, that is, script to be executed or the code included within the script may be adopted. For example, a configuration in which an event complying with an identifier is generated according to the execution of code Y due to the addition, to the script, of code Y in which the identifier is set as a parameter by proxy server device 12 in step S104 (FIG. 8). In this modification with such a configuration, a script to be executed or a code that is included within the script to be executed can by identified by an identifier that complies with an event generated according to execution of the script. Accordingly, modifications are made to tree data according to rules that differ according to the location in which code Y is added, by storing, in the field “event type” of the rule data (FIG. 11), data that specifies an event that indicates execution of code Yin compliance with a specific identifier, for example.

### Thirteenth Modification

In the above-described embodiment or modifications, the program executed by the computer to realize terminal device 11, proxy server device 12 or Web server device 13 may be provided in the form of being downloaded onto the computer via a network, or may be provided in the form of being continuously recorded in a computer-readable recording medium such as a CD-ROM or a flash memory, and used by being read from the recording medium by the computer.

### EXPLANATION OF THE REFERENCE NUMERALS

1 . . . Web page display system
9 . . . network
11 . . . terminal device
12 . . . proxy server device
13 . . . Web server device
111 . . . transmission unit
112 . . . reception unit
113 . . . execution unit
114 . . . generation unit
115 . . . detection unit
116 . . . determination unit
117 . . . modification unit
118 . . . display instruction unit
121 . . . reception unit
122 . . . transmission unit
123 . . . adding unit
131 . . . reception unit
132 . . . acquisition unit
133 . . . transmission unit
1101 . . . memory
1102 . . . processor
1103 . . . communication interface
1104 . . . touch display
1201 . . . memory
1202 . . . processor
1203 . . . communication interface
1301 . . . memory
1302 . . . processor
1303 . . . communication interface

What is claimed is:

1-21. (canceled)

22. A computer program that causes a computer to execute processes comprising:
a determination process for determining whether a tree structure indicated by generated tree data includes one or more branches that satisfy predetermined conditions;
a modification process for modifying the one or more branches according to predetermined rules if it is determined in the determination process that one or more branches that satisfy the predetermined conditions are included; and
a display instruction process for instructing a display device to display a Web page according to tree data that has been modified in the modification process, the computer generating the tree data indicating in a tree structure relations among elements included in a Web page that is displayed according to display instruction data, and which instructs display of a Web page.

23. A computer program set forth in claim 22, which causes the computer to carry out processes comprising:
a detection process for detecting generation of a predetermined event, and
the determination process if generation of a predetermined event is detected in the detection process.

24. A computer program set forth in claim 23, which causes the computer to carry out a process comprising:
modification, in the modification process, of branches according to the predetermined rules that differ according to the predetermined event that has been detected as being generated in the detection process.

25. A computer program set forth in claim 24, which causes the computer to carry out a process comprising:
detection, in the detection process, of execution by the computer of a program according to the display instruction data or execution by the computer of a code included in the program as generation of the predetermined event that differs from the program or the code.

26. A computer program set forth in claim 23, which causes the computer to carry out a process comprising:
detection, in the detection process, of execution by the computer a program according to the display instruction data or execution by the computer of a code included in the program as generation of the predetermined event.

27. A computer program set forth in claim 22, comprising:
at least a part that is included in the display instruction data.

28. A computer program that causes a computer, which transmits, to a terminal device, display instruction data that instructs display of a Web page, to carry out processes comprising:
an adding process for adding a code that causes the terminal device to generate an event indicating execution of a program or a code included in the program, if at least a part of the program is included in the display instruction data, and
a transmission process for transmitting, to the terminal device, the display instruction data to which a code has been added in the adding unit.

29. A computer program set forth in claim 28, which causes the computer to carry out a process comprising:
addition, in the adding process, of a code that causes the terminal device to generate events that differ according to a program or a code included in the program to be executed, as events that indicate execution of the program or the code.

30. A computer program that causes a computer, which transmits, to a terminal device, display instruction data that instructs display of a Web page, to carry out processes comprising:
an adding process for adding, to the display instruction data, a program that causes the terminal device to carry out a process of acquiring the program set forth in claim 22 from a server device, and
a transmission process for transmitting, to the terminal device, the display instruction data to which the program has been added in the adding process.

31. A computer program set forth in claim 30, wherein
the program added to the display instruction data in the adding process causes the terminal device to carry out a process of transmitting, to a server device, attribute data indicating attributes of the terminal device or attributes of a user of the terminal device.

32. A computer program that causes a computer, which transmits, to a terminal device, display instruction data that instructs display of a Web page, to carry out processes comprising:
an adding process for adding, to the display instruction data, the program set forth in claim 22, and
a transmission process for transmitting, to the terminal device, the display instruction data to which the program has been added in the adding process.

33. A terminal device comprising:
an acquisition unit for acquiring display instruction data that instructs display of a Web page;
a generation unit for generating tree data that indicates, by using a tree structure, relations among elements included in the Web page that is displayed according to the display instruction data acquired by the acquisition unit;
a determination unit for determining whether or not the tree structure indicated by the tree data generated by the generation unit includes one or more branches that satisfy predetermined conditions;
a modification unit for modifying the one or more branches according to predetermined rules if it is determined by the determination unit that one or more branches that satisfy the predetermined conditions are included; and
a display instruction unit for instructing a display device to display a Web page according to the tree data generated by the generation unit, and if the tree data has been modified by the modification unit, instructs the display device to display a Web page according to the modified tree data.

34. A terminal device set forth in claim 33, comprising:
a detection unit for detecting generation of a predetermined event, wherein
the determination unit carries out the determination if generation of the predetermined event is detected by the detection unit.

35. A terminal device set forth in claim 34, wherein
the modification unit modifies branches according to the predetermined rules that differ according to the predetermined event for which generation has been detected by the detection unit.

36. A terminal device set forth in claim 35, comprising:
an execution unit for executing a program according to the display instruction data or a process according to a code included in the program, wherein
the detection unit detects events that differ according to the program or the code executed by the execution unit.

37. A terminal device set forth in claim 34, comprising:
an execution unit for executing a process according to a program according to the display instruction data or a code included in the program, wherein
the detection unit detects execution of the program or the code included in the program by the execution unit as generation of an event.

38. A server device comprising:
an adding unit for adding a code that causes a terminal device to generate an event that indicates execution of a program or a code included in the program, if at least a part of the program is included in display instruction data that instructs display of a Web page, and
a transmission unit for transmitting, to the terminal device, the display instruction data to which the code has been added by the adding unit.

39. A server device set forth in claim 38, wherein
the adding unit adds a code that causes the terminal device to generate events that differ according to a program or a code included in the program to be executed, as an event that indicates execution of the program or the code.

40. A server device comprising:
an adding unit for adding, to display instruction data that instructs display of a Web page, a program that causes a terminal device to acquire the program set forth in claim 22 from the server device, and
a transmission unit for transmitting, to the terminal device, the display instruction data to which the program has been added by the adding unit.

41. A server device set forth in claim 40, wherein
the adding unit adds, to the display instruction data, a program that causes the terminal device to carry out a process of transmitting, to the server device, attribute data that indicates attributed of the terminal device or attributes of a user of the terminal device.

42. A server device comprising:
an adding unit for adding, to display instruction data that instructs display of a Web page, the program set forth in claim 22, and
a transmission unit for transmitting, to a terminal device, the display instruction data to which the program has been added by the adding unit.
